(19) United States
(12) Patent Application Publication
(10) Pub. No.: US 2014/0143761 A1
(43) Pub. Date: May 22, 2014

(54) METHOD AND SYSTEM FOR DATABASE CONVERSION

(71) Applicants: Natalio Fridman, New York, NY (US); Eduardo Alberto Namur, San Paulo (BR)

(72) Inventors: Natalio Fridman, New York, NY (US); Eduardo Alberto Namur, San Paulo (BR)

(21) Appl. No.: 13/865,995

(22) Filed: Apr. 18, 2013

Related U.S. Application Data
(60) Provisional application No. 61/625,871, filed on Apr. 18, 2012.

(51) Int. Cl. G06F 9/45

(52) U.S. Cl. CPC G06F 8/51
USPC 717/137

(57) ABSTRACT

A system and method for converting legacy program code to up to date program code is provided. The system and method includes a compiler having four modules—a parser, a transformer, an optimizer, and a code generator. The parser reads the code and analyzes the code by identifying key words, identifying key contextual indicators, and identifying inefficiencies in the code. The transformer translates the legacy program code to the up to date program code using a translation table. The optimizer reduces inefficiencies in the transformed code.

### RELATED APPLICATION(S)

This Application claims priority to Provisional Patent Application Ser. No. 61/625,871, filed on Apr. 18, 2012, which is hereby incorporated by reference.

### FIELD OF THE INVENTION

This invention relates to a method and system for converting computer program products from one computer programming language to another. The method includes steps relating to parsing source code, analyzing the code, transforming the code, optimizing the code, and saving a transformed version of the code.

### BACKGROUND OF THE INVENTION

Many legacy computer systems, especially legacy computer systems relying on large amounts of data, are still relied upon despite significant advantages associated with new advancements in computer programming. Additionally, maintenance of these legacy systems is very expensive because there is limited group of programmers knowledgeable with the proper knowledge and the legacy systems were rarely designed with modern computing power and expectations in mind.

Nevertheless, the legacy systems continue to be relied upon because the process of converting code and data to newer languages in overly burdensome and cost prohibitive.

### SUMMARY OF THE INVENTION

A system and method for converting legacy program code to up to date program code is provided. The system and method includes a compiler having four modules—a parser, a transformer, an optimizer, and a code generator. The parser reads the code and analyzes the code by identifying key words, identifying key contextual indicators, and identifying inefficiencies in the code. The transformer translates the legacy program code to the up to date program code using a translation table. The optimizer reduces inefficiencies in the transformed code.

### BRIEF DESCRIPTION OF THE DRAWINGS

The above-described and other advantages and features of the present disclosure will be appreciated and understood by those skilled in the art from the following detailed description and drawings of which,

FIG. 1 is schematic view of the method and system of the present invention;

FIG. 2 is graphical representation of the Data Migration System of the present invention;

FIG. 3 is a graphical representation of a ADABAS database relating to the present invention;

FIG. 4 is a graphical representation of related fields of the present invention;

FIG. 5 is a graphical representation of the compiler operation of the present invention;

FIG. 6 is a graphical representation of the compiler architecture of the present invention;

FIG. 7 is an outline of the main stages of the conversion process of the present invention;

FIG. 8 is a graphical representation of the relationship between different class elements of the present invention;

FIG. 9 is a flow chart illustrating the database statement transformation of the present invention;

FIG. 10 is a flow chart illustrating the process of transforming database access commands to SQL statements of the present invention;

FIG. 11 is a graphical representation of the conversion from ADABAS to SQL of the present invention;

FIG. 12 is a graphical representation of the conversion and execution of applications developed with the Natural/RDB programming language of the present invention;

FIG. 13 is a graphical representation of translation of ADABAS to SQL of the present invention;

FIG. 14 is a graphical representation of the converter/compiler of the present invention; and

FIG. 15 is a graphical representation of the user interface access points of the present invention.

### DETAILED DESCRIPTION OF THE INVENTION

The method and system of the present invention provides the ability to compile the source code relating to a database generated in NATURAL/ADABAS so that the compiled code may be read by an SQL program

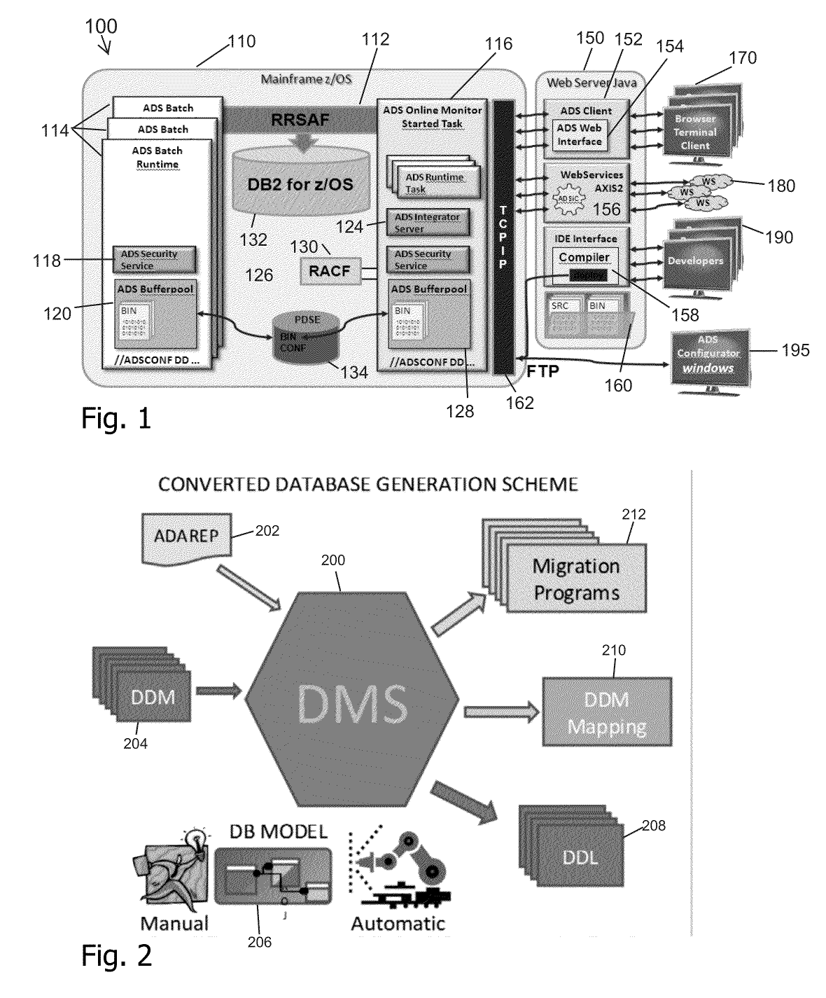

FIG. 1 illustrates the overall architecture of the present invention. The system 100 includes a Mainframe 110 (preferably a z/OS Mainframe), a Web Server 150 (preferably a Java™ Web Server), a plurality of Browser Terminal Clients 170, a plurality of web services 180, a plurality of developers 190, and an Application Development Solution (“ADS”) Configurator 195 running Windows™. The term Advanced Development Solution or ADS is used throughout to refer to elements of the present invention, here a Configurator.

The mainframe 110 further includes a Resource Recovery Service Attachment Facility 112 (“RRSAF”) connected between a plurality of ADS Batch Runtimes 114 and an ADS Online Monitor Started Task 116. The ADS Batch Runtimes 114, each include an ADS Security Service 118 and an ADS Bufferpool 120. The ADS Online Monitor Started Task 116 includes a plurality of ADS Runtime Tasks 122, an ADS Integrator Server 124, an ADS Security Service 126, and an ADS Bufferpool 128. Further, a Resource Access Control Facility 130 (“RACE”) is connected to the ADS Online Monitor Started Task 128. The RRSAF 112 loads information into a DB2 database 132. Additionally, a Partitioned Data Set Extender 134 (“PDSE”) is provided between the ADS Bufferpool 120 and the ADS Bufferpool 128.

The Web Server 150 further includes: an ADS Client 152, having an ADS Web Interface 154; a Web Services Engine 156 (preferably a Webservices AXIS2); and an Integrated Development Environment (“IDE”) Interface 158, which includes a Compiler 160. Connected to the ADS Client 152 is the plurality of Browser Terminal Clients 170. Connected to the Web Services Engine 156 is the plurality of Web Services 180. Connected to the IDE Interface 158 is the plurality of Developers 190.

The Web Server 150 is connected to the Mainframe 110 by a TCP/IP connection 162. Additionally, the ADS Configurator 195 connects to the Mainframe 110 by the TCP/IP connection 162 via File Transfer Protocol (FTP).

FIG. 2 illustrates the Data Migration System 200 (“DMS”) and the process of data migration. The DMS 200 receives a report 202 (called ADAREP), which is produced by the ADABAS utilities indicating the internal format and contents of its files, fields, and allocation information. Together with the Data Definite Module (“DDM”) 204 (from Natural/ADABAS), information about the original data and how it is manipulated in the original environment is provided to the DMS 200. Either through a manual or automatic process, the DMS 200 creates a Database (“DB”) Model 206. Then the DMS 200 provides a Data Definition Language 208 (“DDL”) to create tables in the target environment and provide a Data Definition Module (“DDM”) Mapping 210, which together include the information required to rebuild the proper access in the target platform, in correspondence to each one of the original accesses. Lastly, the DMS outputs to a plurality of Migration Programs 212.

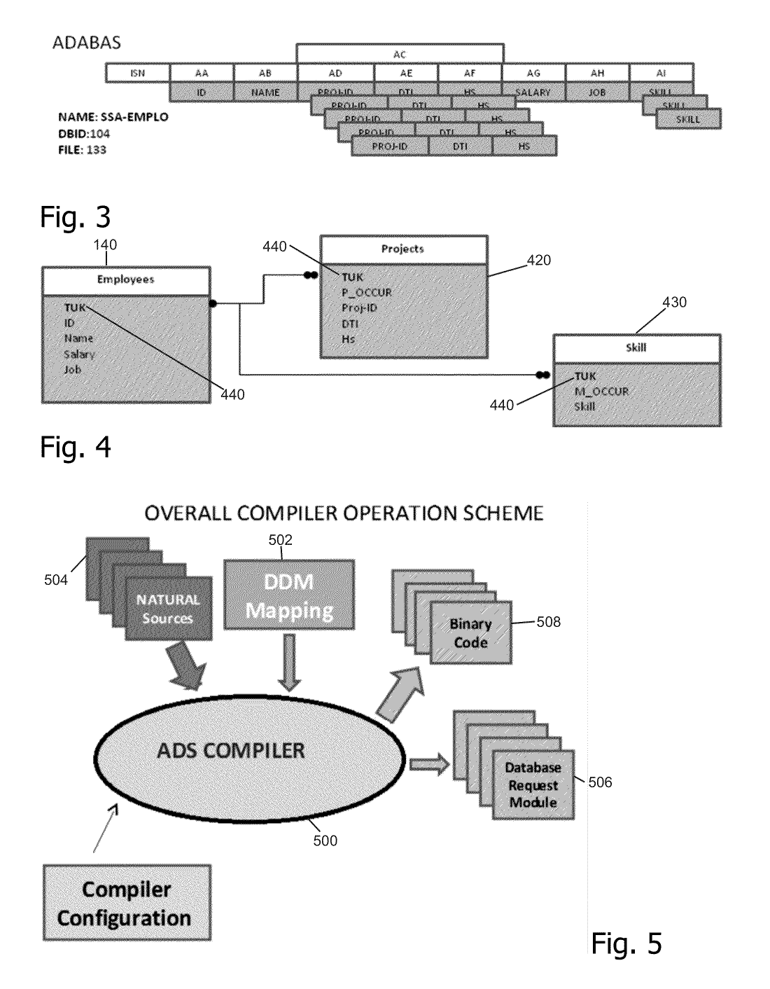

FIG. 3 illustrates an example of part of the DMS Data Conversion process. Based on Fast Data Transfers (“FDT”) and DDMs from the output of the ADABAS DECOMPRESS, the DMS creates a DLL of all original tables and LOAD files for target Relational Database Management Systems (“RDBM”).

Multiple and Periodic fields from the ADABAS database are converted into distinct tables, as illustrated in the example of FIG. 4. The tables 410, 420, 430 are linked by a foreign key 440 that represents the original identifier. In the example of FIG. 4, the identifier is TUK. Super-descriptors and Sub-descriptors (e.g., ID, Name, Salary, Job, P-OCCUR, Proj-ID, DTI, HS, M_OCCUR, and Skill) are stored as filed of the tables.

The compiler process is responsible for the transformation that maps the original access to ADABAS into the SQL statements that access the migrated data.

The Compiler 500 is illustrated in FIGS. 5 through 7. The Compiler 500 receives Natural source code and DDM Mapping information 502 and outputs binary code that can be used by an SQL system. Additionally, the Compiler 500 outputs to a Database Request Module.

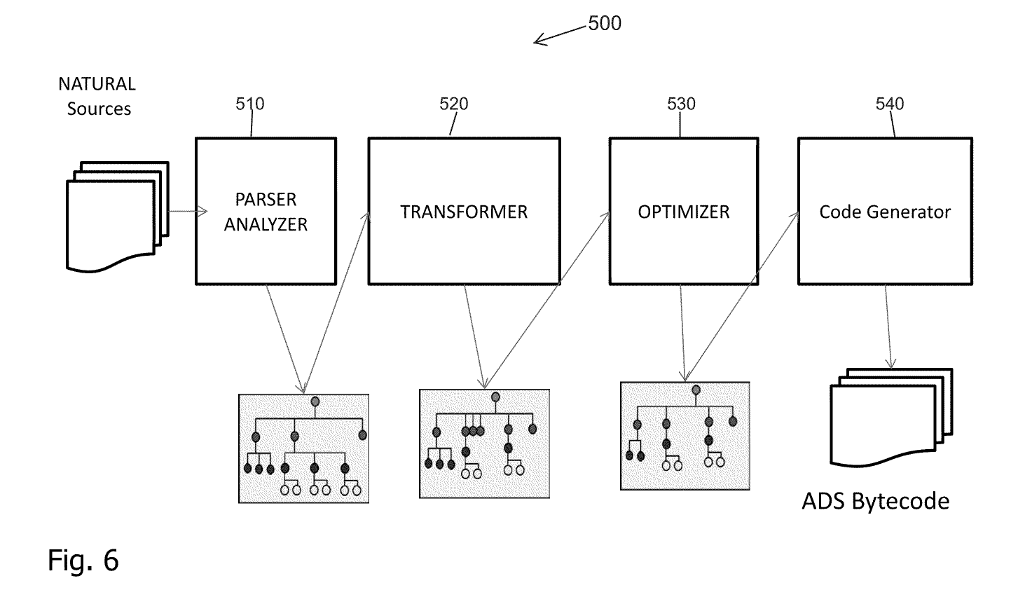

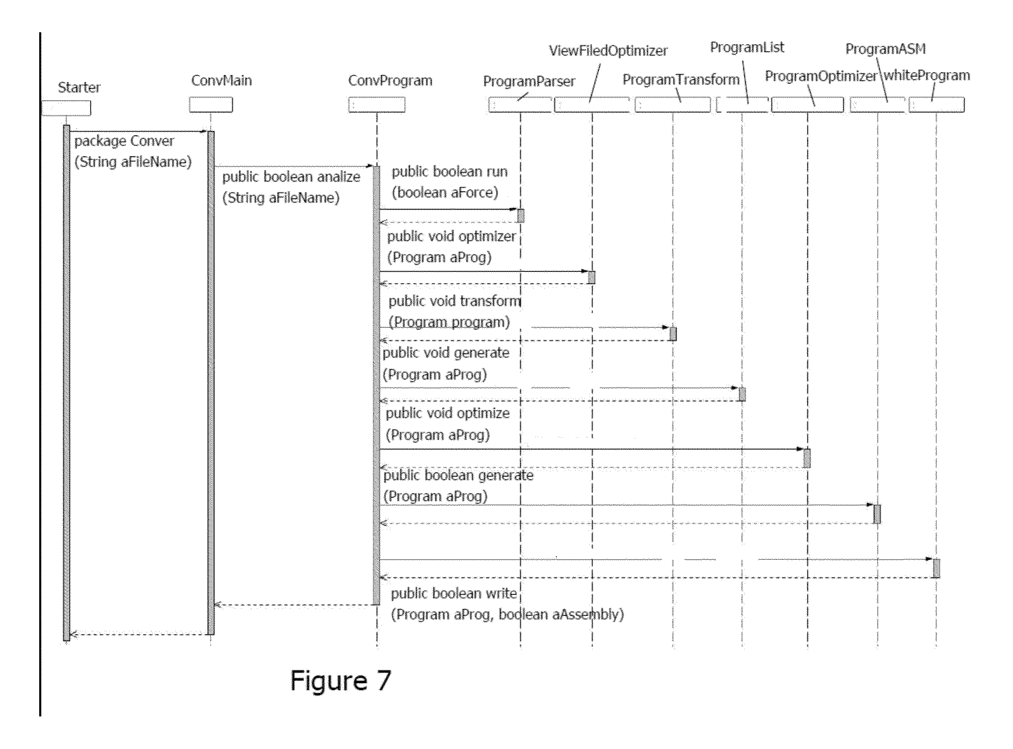

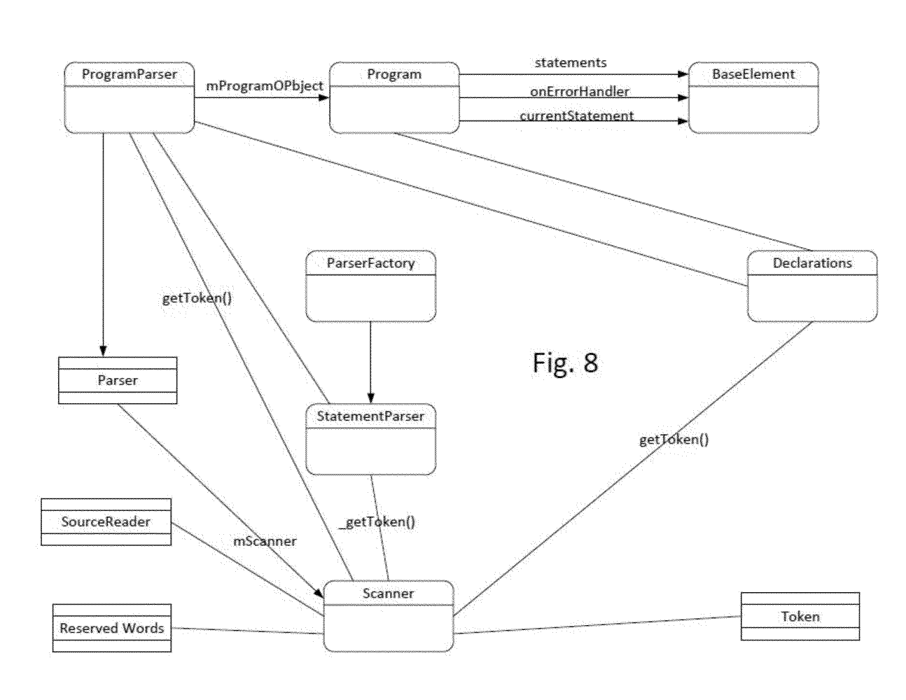

FIGS. 5 and 6 illustrate the compiler 500 process. Based on the options described in the configuration file, the NATURAL sources 504 are compiled and the database accessing statements used to get or put data into ADABAS are transformed in SQL statements instead. These statements can reside in Database Request Modules 506, the modules responsible for the actual access to the relational database. The Compiler 500 outputs Binary Code 508

The Compiler 500 includes four modules, a Parser/Analyzer 510, a Transformer 520, an Optimizer 530, and a Code Generator 540. The Parser 510 separates the original source code into separate components, data structures, and instructions. As part of this process, the Parser 510 identifies code from a table of reserved words that mark the beginning of an instruction/statement. Upon identification of a valid instruction/statement, the Parser 510 calls a proper analyzer, e.g., parserFactory. Additionally, the Parser 510 identifies the context of the code within the source code. In particular, the Parser 510 identifies: alternative syntax, clauses, attributes, modifiers, operands, and tab spacing. (Certain objects may have declarative data in tabular form, and this data is identified.) The output of the Parser 510 is a Base Element Tree. The Base Element Tree is a hierarchical data structure of objects that represents the components and sequence of instructions found on a program object. Example elements of a Base Element Tree are provided in Table 2.

Some of the source code elements identified by the Parser 510 are unsupported in SQL. Other elements include multiple and periodic fields that lack singular equivalent elements in SQL.

In addition, the Parser 510 searches the source code for command elements that are not necessary for execution of the computer program product, for example: unused variables, subroutines not called, and empty instruction blocks. The Parser 510 also determines whether or not the order of the database elements is to be transferred to the SQL code; this determination may include a manual input from a user.

The Transformer 520 converts the Base Element Tree to an Abstract Syntax Tree. Thus each field in the original database is mapped to a column name. In doing so, the Transformer 520 maps the unsupported elements to equivalent elements in SQL. Example equivalent elements are provided in Table 1. Additionally, the Transformer 520 checks the type of DDM (ADABAS or SQL), as some source files may contain a combination of both, and the Transformer 520 obtains mapping definitions from a DDMMAPPING file. The DDMMAPPING file is a text file that contains records grouped into three categories: [CONFIG]—configuration parameters; [TABLE]—relational database table description; and [DDM] NATURAL view names assigned to relational tables and field names assigned to column names.

Where the Transformer 520 identifies multiple and periodic fields, the Transformer 520 generates multiple elements in SQL to correspond to the individual multiple or periodic field.

The Optimizer 530 modifies the transformed code to increase efficiency. In particular, the Optimizer 530 eliminates elements that are not necessary for execution of the computer program product, e.g., unused variables, subroutines not called, and empty instruction blocks. The Optimizer 530 also combines identical instructions, previously identified by the Parser 510.

Lastly, the Code Generator 540 consolidates the transformed and optimized code and provides it to the system.

FIG. 7 shows an outline of the main stages of the conversion process. The outline shows the conversion processes for external data areas (global, local parameters) and DDM.

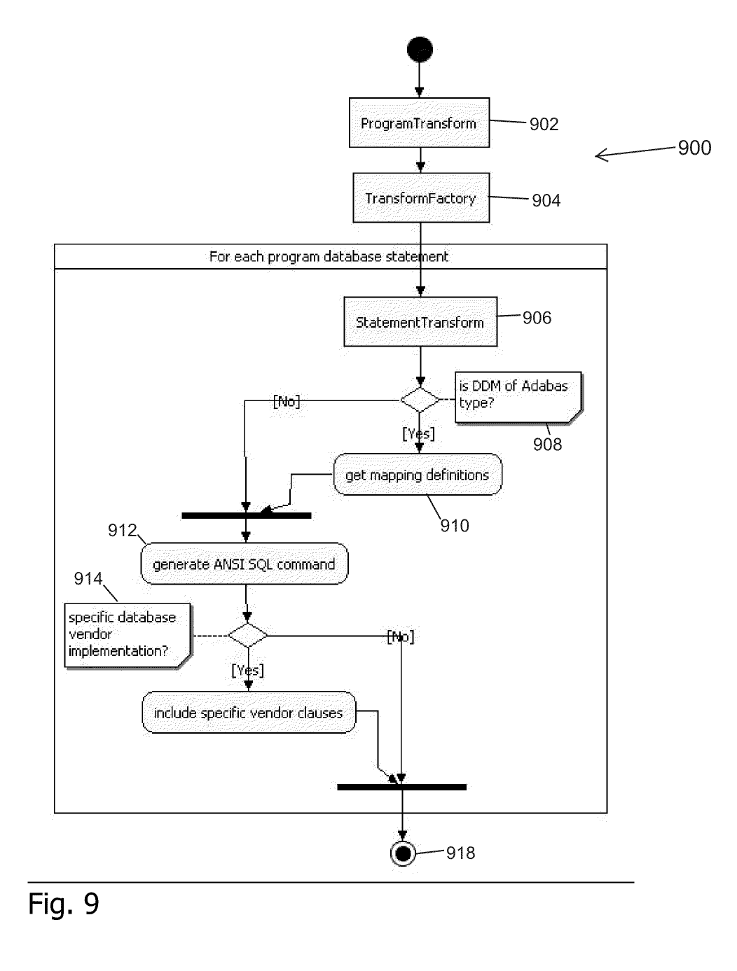

FIG. 9 illustrates an example of the transformation process 900. The Process 900 loads a ProgramTransform 902 and a TransformFactory 904. For each database statement, the process loads a StatementTransform 906 determines if the statement is of the ADABAS type 908. If the statement is not ADABAS, the process 900 proceeds to generate ANSI SQL command 912; if the statement is ADABAS, then the process 900 gets mapping definitions for conversion and converts the statement 910 and generates an ANSI SQL command 912. Next, the process 900 determines if a specific vendor implementation is appropriate 914. If no specific vendor implementation is appropriate, the process outputs the ANSI SQL command 918; if a specific vendor implementation is appropriate, the process adds the vendor implementation to the ANSI SQL command 916 and outputs the modified command 918.

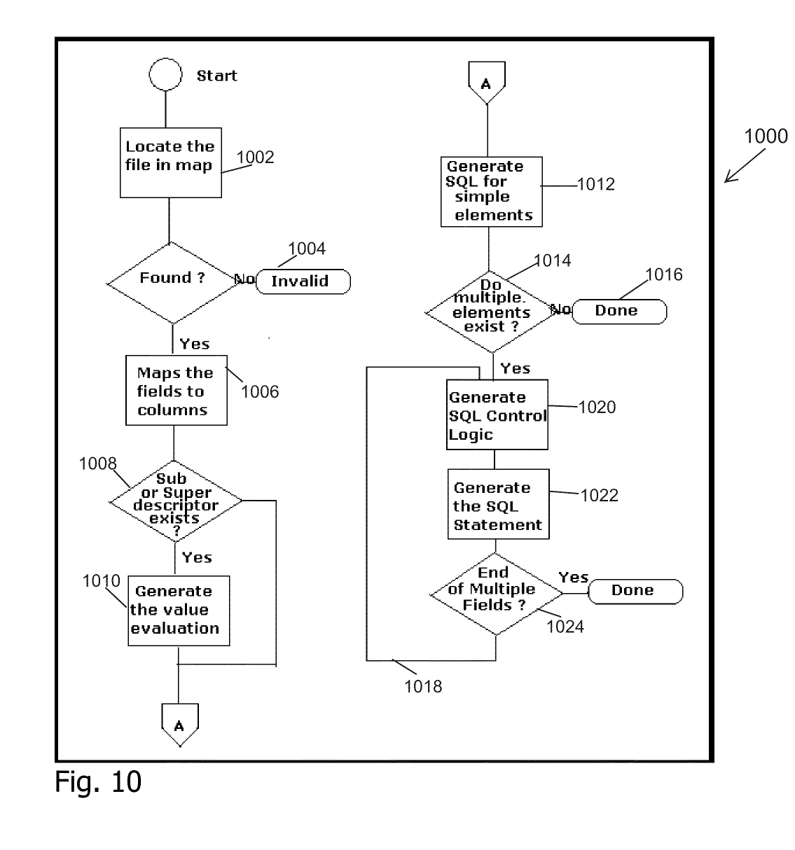

FIG. 10 is a flow chart illustrating an example of the process 1000 of transforming database access commands to SQL statements. The process locates the appropriate file in a map 1002. If not found, the command is invalid 1004; if found, the process maps the fields to columns 1006. Next, the process 1000 determines if a sub-descriptor or a super-descriptor exists 1008. If not, the process generates SQL statements for simple elements 1012. If a sub-descriptor or a super-descriptor exists, the process generates a value evaluation 1010 and then generates the SQL simple elements 1012. If no multiple elements (e.g., a Multiple and Periodic field) exist 1014, the process is complete 1016. If multiple elements exist, the process proceeds in a loop 1018 to generate SQL control logic 1020 and an SQL statement 1022 for each element until all elements are accounted for 1024.

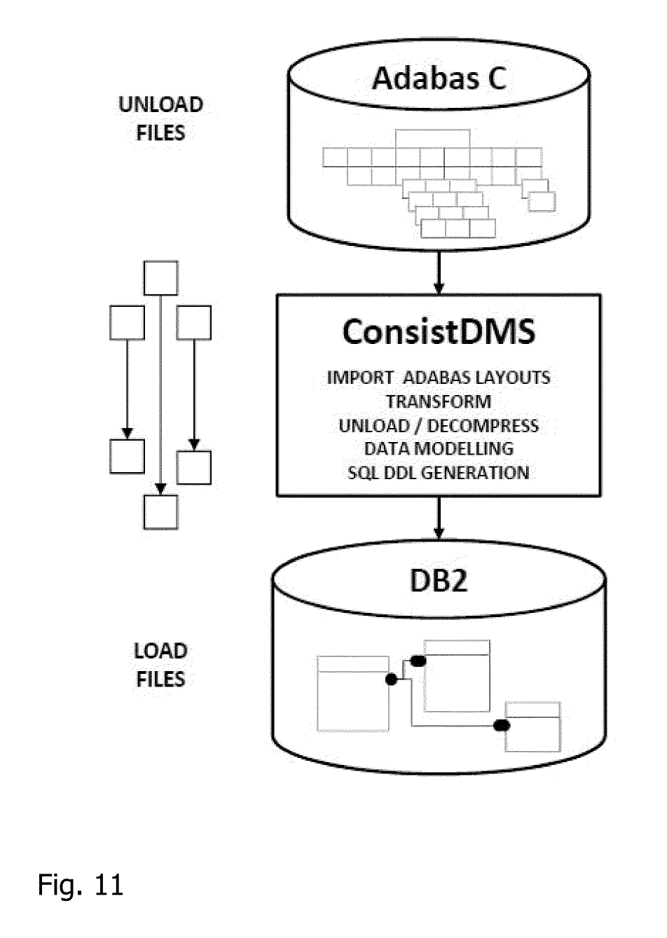

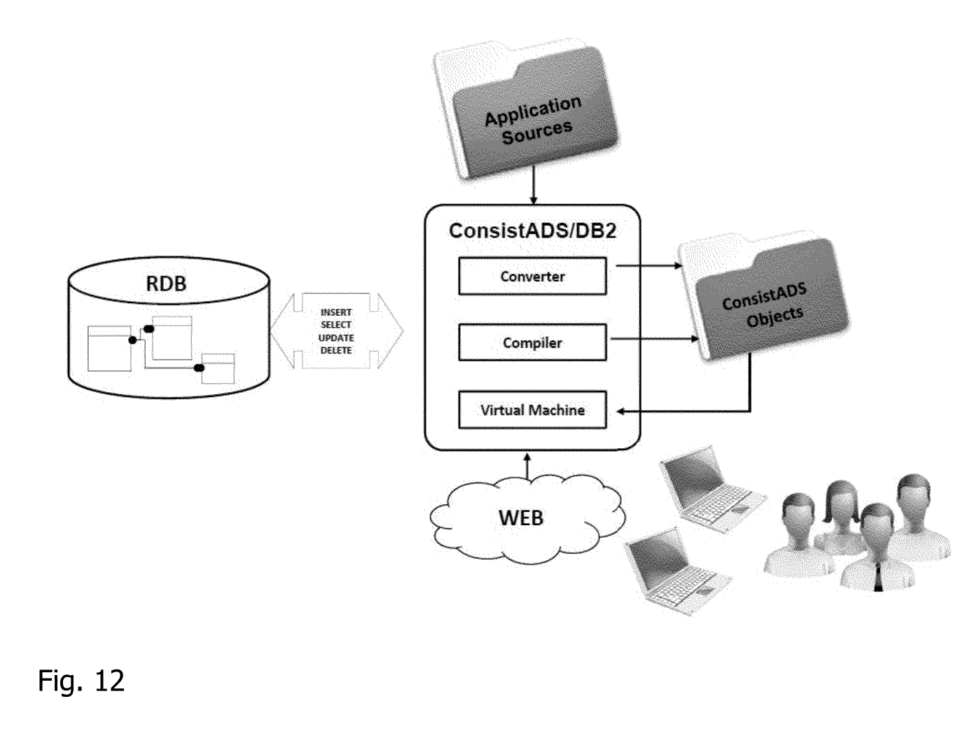

FIG. 11 is graphical representation of the overall conversion process. The figure shows an ADABAS database passing through an ADS program resulting in a SQL compatible Database (DB2). FIG. 12

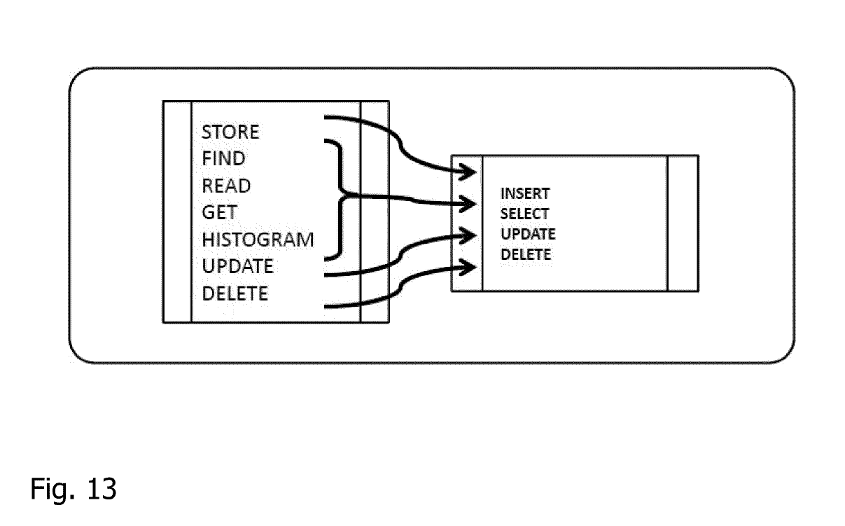

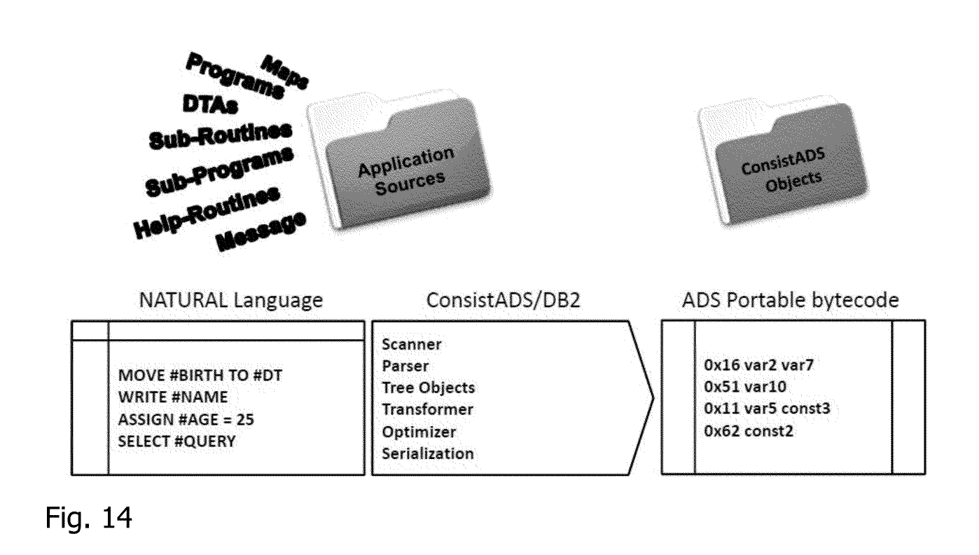

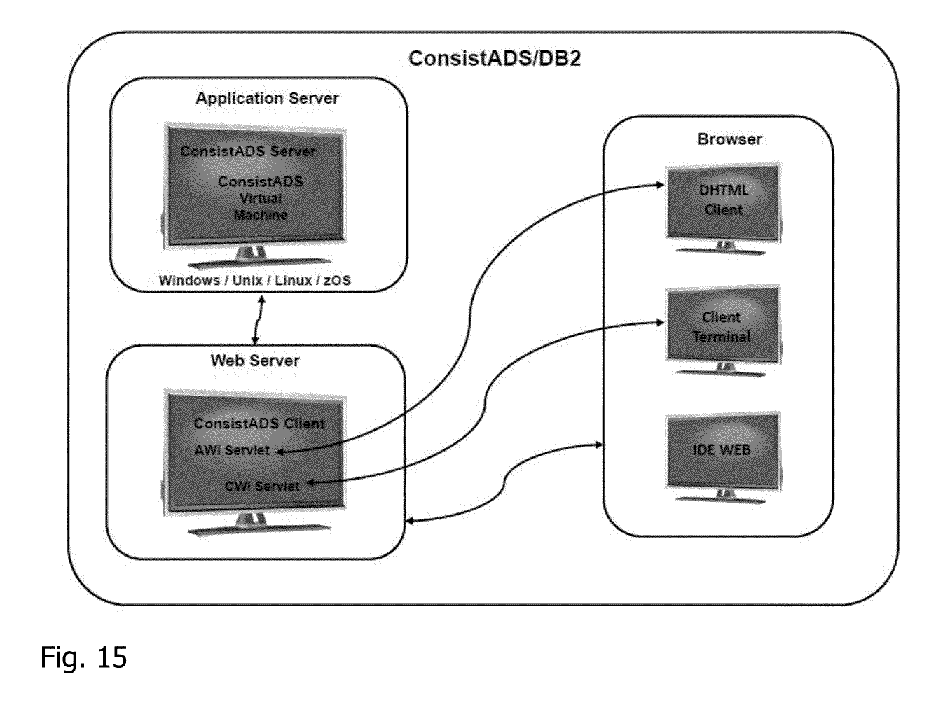

FIG. 13 illustrates an example of the Transformer 520 of the compiler. In particular, the command STORE is translated to the statement INSERT, the commands FIND, READ, GET, and HISTOGRAM are translated to the statement SELECT; and the commands UPDATE and DELETE are unchanged.

Table 3 provides samples of code transformation from ADABAS to SQL. In the first example of the table, the HISTOGRAM command from the source code (left side column) is translated into a SELECT statement in the new code (right side column).

The accompanying drawings only illustrate several examples of a method and system for database conversion and its respective constituent parts, however, other types and styles are possible, and the drawings are not intended to be limiting in that regard. Thus, although the description above and accompanying drawings contain much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. A computer implemented method for converting a computer program product stored on a physical medium from a first programming language to a second programming language, comprising:
analyzing the computer program product to identify individual commands within the computer program product, where the individual commands include command elements;
identifying command elements that are not necessary for execution of the computer program product;
transforming the individual commands from the first programming language to the second programming language based on a lookup table stored on the physical medium, where the transformed individual commands form a second computer program product;
optimizing the second computer program product by removing the identified command elements that are not necessary for the execution of the computer program product; and
saving the optimized second computer program product on the physical medium.

2. The method of claim 1, wherein one of the individual commands includes multiple subcommands, further comprising:
transforming the one command having multiple subcommands to multiple commands in the second computer program product.
